(19) United States
(12) Patent Application Publication
(10) Pub. No.: US 2013/0048671 A1
(43) Pub. Date: Feb. 28, 2013

(54) Wearable Apparatus for Dispensing a Beverage

(71) Applicants: Zachary Braly, Las Vegas, NV (US); Jorge L. Medina, Las Vegas, NV (US)

(72) Inventors: Zachary Braly, Las Vegas, NV (US); Jorge L. Medina, Las Vegas, NV (US)

(21) Appl. No.: 13/216,053

(22) Filed: Aug. 23, 2011

(51) Int. Cl. B67D 7/06; B67D 7/84

(52) U.S. Cl. 222/129; 222/175

(57) ABSTRACT

An apparatus comprises two beverage dispensers each comprising a top, a bottom, a facing side, an outside side, a front wall, a back wall, a beverage storage portion, a beverage dispensing portion disposed on the front wall, and a liquid control device disposed on the back wall. A connecting mechanism joins the facing sides. Two strap mechanisms each support a beverage dispenser. Each of the two strap mechanisms comprises a first strap portion for joining to the top and for extending over a wearer's shoulder, and a second strap portion for joining to the outside side and for extending about a side of the wearer. The first strap portion and the second strap portion are joined together to support the beverage dispenser on the wearer's shoulder with the beverage dispenser being disposed proximate a breast area of the wearer where the wearer can support the apparatus for dispensing the beverage.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to beverage dispensing systems. More particularly, the invention relates to beverage dispensing systems having the appearance and positioning of female breasts.

### BACKGROUND OF THE INVENTION

Beverages may be consumed via a wide variety of devices, glass, cup, straw, keg, bottle, mug, goblet, decanter, jug, tumbler, canteen, etc.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-B illustrate an example beverage dispensing system, in accordance with an embodiment of the present invention;

FIG. 2 illustrates an enlarged view of a portion of example second beverage dispenser as described with reference to FIGS. 1A-B, in accordance with an embodiment of the present invention;

FIG. 3 illustrates an enlarged view of example second beverage dispenser as described with reference to FIGS. 1A-B and FIG. 2, in accordance with an embodiment of the present invention;

FIGS. 4A-B illustrate a rear view of example beverage dispensing system as described with reference to FIGS. 1A-B, in accordance with an embodiment of the present invention;

FIG. 5A illustrates a view of an example beverage dispensing device with an open liquid control device, in accordance with an embodiment of the present invention;

FIG. 5B illustrates a view of an example beverage dispensing device with a closed liquid control device, in accordance with an embodiment of the present invention;

FIG. 6 illustrates a view of an example beverage dispensing device portraying an amount of liquid contained within the device, in accordance with an embodiment of the present invention;

FIG. 7A illustrates a disconnected connection device for example beverage dispensing device, in accordance with an embodiment of the present invention;

FIG. 7B illustrates a connected connection device for example beverage dispensing device, in accordance with an embodiment of the present invention;

FIG. 8A illustrates an enlarged view of a disconnected connection device for example beverage dispensing device as discussed with reference to FIG. 7A, in accordance with an embodiment of the present invention;

FIG. 8B illustrates an enlarged view of a connected connection device for example beverage dispensing device as discussed with reference to FIG. 7B, in accordance with an embodiment of the present invention; and

FIGS. 9A-B illustrate an example application for example beverage dispensing device, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a variety of wearable apparatus for dispensing a beverage are described.

In one embodiment an apparatus comprises two beverage dispensers each comprising a top, a bottom, a facing side, an outside side, a front wall, a back wall, a beverage storage portion disposed in a volume between the front wall and the back wall, a beverage dispensing portion disposed on the front wall, and a liquid control device disposed on the back wall. A connecting mechanism is configured for joining the facing sides. Two strap mechanisms are each configured for supporting a separate one of the two beverage dispensers. Each of the two strap mechanisms comprises a first strap portion being configured for joining to the top and for extending over a wearer's shoulder, and a second strap portion being configured for joining to the outside side and for extending about a side of the wearer. The first strap portion and the second strap portion are further configured for joining together to support the one of the two beverage dispensers on the wearer's shoulder with the one of the two beverage dispensers being disposed proximate a breast area of the wearer where the wearer can support the apparatus for dispensing the beverage. In another embodiment the back wall comprises an ergonomic shape for fitting the wearer. In yet another embodiment the ergonomic shape comprises a concave portion. Still another embodiment further comprises a covering pad being configured for joining to the back wall and for covering the back wall. In another embodiment each of the two strap mechanisms further comprises a strap joining mechanism being configured for joining the first strap portion to the second strap portion and for adjusting a length of one of the first strap portion and the second strap portion. In yet another embodiment each of the two strap mechanisms further comprises a first joining portion for joining the first strap portion to the top. The first joining portion comprises a first strap being configured for joining to the top, a first joining mechanism being configured for joining to the first strap, an extending strap being configured for joining to the first joining mechanism, and an extending strap mechanism being configured for joining the extending strap to the first strap portion. In still another embodiment each of the two strap mechanisms further comprises a second joining portion for joining the second strap portion to the outside side. The second strap portion comprises a second strap, being configured for joining to the outside side, and a second mechanism being configured for joining the second strap to the second strap portion. In another embodiment each of the first joining portions further comprises an additional strap being configured for joining to the top, an additional joining mechanism being configured for joining to the additional strap, an additional extending strap being configured for joining to the additional joining mechanism and to the extending strap mechanism. In yet another embodiment the liquid control device comprises a collapsible throat insert, a snap ring being joined to the throat insert, and a cap device being configured for joining to the snap ring and for sealing the liquid control device. In still another embodiment the beverage dispensing portion comprises a nipple being configured for dispensing the beverage and a ring device surrounding the nipple. In another embodiment the nipple comprises a vertical opening and a horizontal opening being configured to release the beverage. In yet another embodiment the beverage dispensing portion is configured to be removable from the front wall. In still another embodiment the strap joining mechanism comprises a side release buckle. In another embodiment the nipple is configured to resemble a nipple of a human female breast. In yet another embodiment the ring device is configured to resemble an areola of a human female breast.

In another embodiment an apparatus comprises first means for dispensing a beverage, first means for covering a back wall of the first dispensing means, first means for supporting the first dispensing means on a first shoulder of a wearer with the first dispensing means being disposed proximate a first breast area of the wearer, second means for dispensing a beverage, second means for covering a back wall of the second dispensing means, second means for supporting the second dispensing means on a second shoulder of the wearer with the second dispensing means being disposed proximate a second breast area of the wearer, and means for joining the first dispensing means and the second dispensing means where the wearer can support the apparatus for dispensing the beverage.

In another embodiment an apparatus comprises a first beverage dispenser comprising a top, a bottom, a facing side, an outside side, a front wall, a back wall, a beverage storage portion disposed in a volume between the front wall and the back wall, a beverage dispensing portion removably disposed on the front wall, and a liquid control device disposed on the back wall. The back wall comprises an ergonomic concave portion for fitting a wearer. The beverage dispensing portion comprises a nipple being configured for dispensing the beverage and a ring device surrounding the nipple. The nipple comprises a vertical opening and a horizontal opening being configured to release the beverage. The liquid control device comprises a collapsible throat insert, a snap ring being joined to the throat insert, and a cap device being configured for joining to the snap ring and for sealing the liquid control device. A first covering pad is configured for joining to the back wall of the first beverage dispenser and for covering the back wall. A first strap mechanism is configured for supporting the first beverage dispenser. The first strap mechanism comprises a first strap portion being configured for joining to the top and for extending over a first shoulder of the wearer, and a second strap portion being configured for joining to the outside side and for extending about a side of the wearer. The first strap portion and the second strap portion are further configured for joining together to support the first beverage dispensers on the first shoulder of the wearer with the first beverage dispensers being disposed proximate a first breast area of the wearer. A second beverage dispenser comprises a top, a bottom, a facing side, an outside side, a front wall, a back wall, a beverage storage portion disposed in a volume between the front wall and the back wall, a beverage dispensing portion removably disposed on the front wall, and a liquid control device disposed on the back wall. The back wall comprises an ergonomic concave portion for fitting the wearer. The beverage dispensing portion comprises a nipple being configured for dispensing the beverage and a ring device surrounding the nipple. The nipple comprises a vertical opening and a horizontal opening being configured to release the beverage. The liquid control device comprises a collapsible throat insert, a snap ring being joined to the throat insert, and a cap device being configured for joining to the snap ring and for sealing the liquid control device. A second covering pad is configured for joining to the back wall of the second beverage dispenser and for covering the back wall. A second strap mechanism is configured for supporting the first beverage dispenser. The first strap mechanism comprises a second strap portion being configured for joining to the top and for extending over a second shoulder of the wearer, and a second strap portion being configured for joining to the outside side and for extending about a side of the wearer. The first strap portion and the second strap portion are further configured for joining together to support the second beverage dispensers on the second shoulder of the wearer with the second beverage dispensers being disposed proximate a second breast area of the wearer. A connecting mechanism is configured for joining the facing side of the first beverage dispenser and the facing side of the second beverage dispenser where the wearer can support the apparatus for dispensing the beverage. In another embodiment the beverage dispensing portion is configured to be removable from the front wall. In yet another embodiment the nipple is configured to resemble a areola nipple of a human female breast. In still another embodiment the ring device is configured to resemble an areola of a human female breast.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination. The Applicants hereby give notice that new Claims may be formulated to such features and/or combinations of such features during the prosecution of the present Application or of any further Application derived there from.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Embodiments of the present invention will be described for providing a beverage dispensing system. Beverage dispensing system provides beverage containment devices for dispensing beverages. Beverage containment devices have the appearance of female breasts. The positioning of the beverage dispensing system mimics the positioning of a female breast.

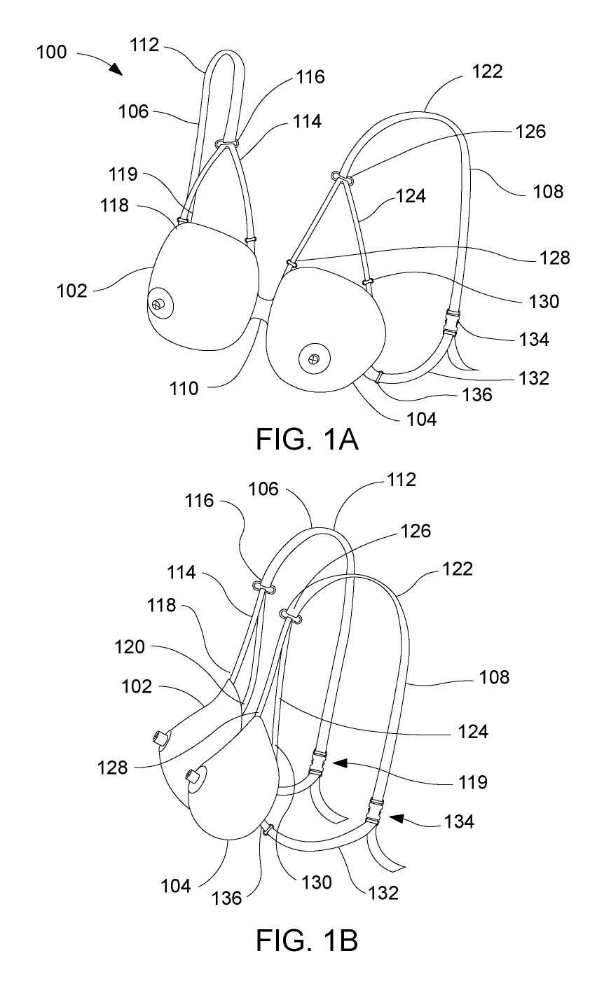

FIG. 1A illustrates an example beverage dispensing system, in accordance with an embodiment of the present invention.

A beverage dispensing system 100 includes a first beverage dispenser 102, a second beverage dispenser 104, a first strap 106, a second strap 108 and a connecting mechanism 110.

Beverage dispensing system 100 provides a system for supplying consumable beverages on demand.

First beverage dispenser 102 and second beverage dispenser 104 provide beverages for consumption.

First strap 106 provides physical support for first beverage dispenser 102.

Second strap 108 provides physical support for second beverage dispenser 104.

Connecting mechanism 110 connects first beverage dispenser 102 to second beverage dispenser 104. As a non-limiting example, connecting mechanism 110 may be configured as a horizontal strap. Furthermore, as a non-limiting example, connecting mechanism 110 may be fabricated of a nylon material. Furthermore, as a non-limiting example, connecting mechanism 110 may be approximately 2.5 inches in length. Furthermore, as a non-limiting example, connecting mechanism 110 may be 0.75 inches in height.

First strap 106 includes a strap 112, a strap 114, a connection device 116, a connection device 118 and a connection device 119.

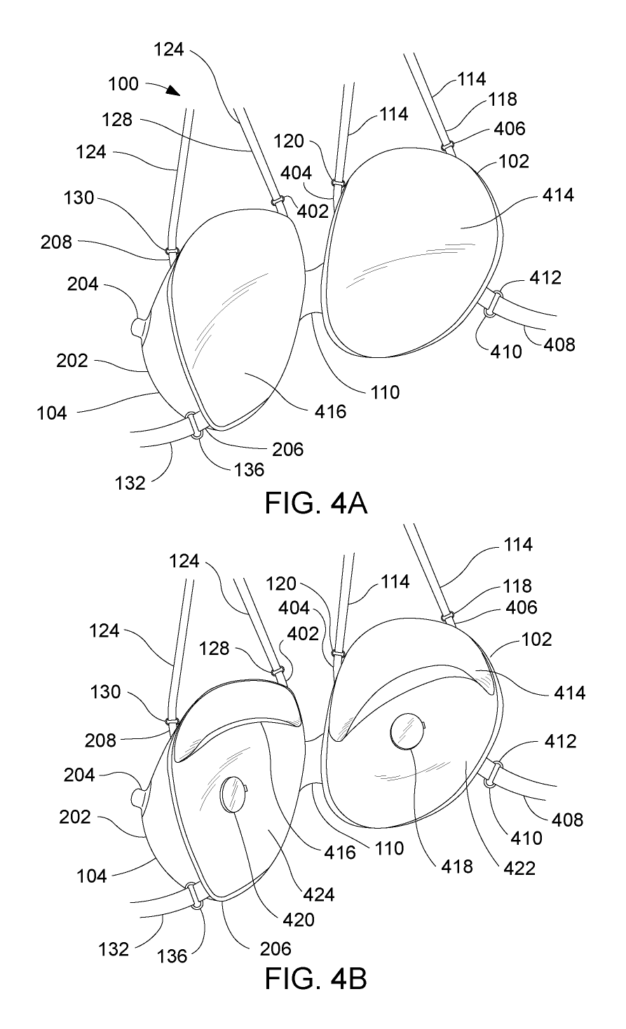

A first end of strap 112 connects to connection device 119. A second end of strap 112 connects to connection device 116. Connection device 119 connects to first beverage dispenser 102 via a connection device and strap (shown in FIG. 4).

Connection device 119 enables adjustment for the length of first strap 106. As a non-limiting example, connection device 119 may be configured as a side release buckle.

Strap 114 traverses through connection device 116. Furthermore, first end of strap 114 connects to connection device 118 and second end of strap 114 connects to a connection device 120. Connection device 118 and connection device 120 connect to first beverage dispenser 102 via straps (shown in FIG. 4).

Second strap 108 includes a strap 122, a strap 124, a connection device 126, a connection device 128, a connection device 130, a strap 132, a connection device 134 and a connection device 136.

Connection device 134 enables adjustment for the length of second strap 108. As a non-limiting example, connection device 134 may be configured as a side release buckle.

As a non-limiting example, first strap 106 and second strap 108 may be fabricated of a nylon material.

A first end of strap 122 connects to connection device 134. A second end of strap 122 connects to connection device 126. Connection device 134 connects to a first end of strap 132. A second end of strap 132 connects to connection device 136. Connection device 136 connects to second beverage dispenser 104 via a strap (shown in FIG. 4).

Strap 124 traverses through connection device 126. Furthermore, first end of strap 124 connects to connection device 130 and second end of strap 124 connects to connection device 128. Connection device 128 and connection device 130 connect to second beverage dispenser 104 via straps (shown in FIG. 4).

First beverage dispenser 102 and second beverage dispenser 104 may store and dispense beverages. Furthermore, beverages may be dispensed easily and in a convenient manner. Non-limiting examples of beverages include water, cola, tea, beer, ale, wine, wine coolers and other alcoholic and non-alcoholic consumables.

Non-limiting examples for applications of beverage dispensing system 100 include social gatherings, holiday events and parties. As a non-limiting example, beverage dispensing system 100 may be worn as part of a costume.

Beverage dispensing system 100 enables the storage, transportation and consumption of beverages without requiring the intervention of a user's hands.

Beverage dispensing system 100 may dispense beverages to the wearer of the system or to non-wearers of the system.

Beverage dispensing system 100 may be configured for insulating beverages. Furthermore, beverages may be maintained within a range of temperature for a period of time.

First strap 106 and second strap 108 may be adjusted to provide a user with a personalized fit.

Non-limiting examples for the material configuration for first strap 106 and second strap 108 include nylon, cotton or a nylon/cotton blend. Furthermore, first strap 106 and second strap 108 may be configured of any known size and width.

First strap 106 and second strap 108 may be configured with any known type of connection device. Non-limiting examples for connection devices include elastic, quick-connect, side release, sliding tab, friction and mating buckles and hook/loop. Furthermore, straps may be configured for one-size-fits-all. Furthermore, straps may be configured without an adjustment mechanism.

First strap 106 and second strap 108 may be configured with a horizontal strap (not shown) located in the rear in order to provide additional support.

First strap 106 and second strap 108 may be padded. Furthermore, first strap 106 and second strap 108 may not be padded.

Beverage dispensing system 100 may be configured for operation located within or covered by a shirt.

A non-limiting example application for beverage dispensing system 100 is as a breast-feeding aid. Furthermore, beverage dispensing system 100 may be used for breast-feeding by non-lactating persons.

A non-limiting example application for beverage dispensing system 100 is as a breast enhancement device for use by an individual who has undergone a mastectomy. Furthermore, beverage dispensing system 100 may be used by an individual with small breasts for purposes of enhancement. Furthermore, beverage dispensing system 100 may be used by an individual with uneven breasts for purposes of enhancement.

FIG. 1B illustrates a side view of the example beverage dispensing system as described previously with reference to FIG. 1A, in accordance with an embodiment of the present invention.

Beverage dispensing system 100 includes two beverage dispensers mimicking the appearance of female breasts. As a non-limiting example, beverage dispensing system 100 mimics the shape, texture and appearance of female breasts. Furthermore, beverage dispensing system 100 may store and dispense beverages.

First beverage dispenser 102 and second beverage dispenser 104 are connected via connecting mechanism 110. As a non-limiting example, connecting mechanism 110 may be configured as a strap.

First beverage dispenser 102 and second beverage dispenser 104 connect to an adjustable shoulder strap enabling beverage dispensing system 100 to be worn upon and projected from a wear's chest.

Beverage dispensing system 100 may be configured with a variety of sizes and shapes. Furthermore, beverage dispensing system 100 may be configured with a variety of skin tones. As a non-limiting example, the skin tones may represent the skin tones of various ethnic groups.

Beverage dispensing system 100 may be configured for a supporting a variety of volumes for the associated liquid to be stored and dispensed.

As a non-limiting example, first beverage dispenser 102 and second beverage dispenser 104 may be fabricated of pliant polyethylene terepthalate (PET) material. Furthermore, first beverage dispenser 102 and second beverage dispenser 104 may be configured in a tear-drop shape similar to a human female breast. Furthermore, first beverage dispenser 102 may support a liquid volume of 32 fluid ounces. Furthermore, second beverage dispenser 104 may support a liquid volume of 32 fluid ounces.

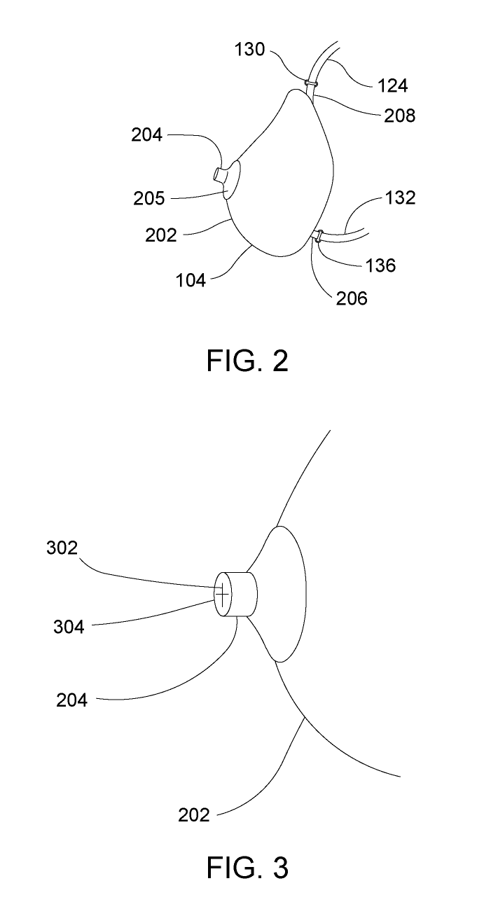

FIG. 2 illustrates an enlarged view of a portion of example second beverage dispenser as described with reference to FIGS. 1A-B, in accordance with an embodiment of the present invention.

For the purposes of discussion, second beverage dispenser 104 will be presented. Furthermore, for brevity of discussion, first beverage dispenser 102 is not discussed in detail. Furthermore, a similar discussion as presented for second beverage dispenser 104 may also be applied to first beverage dispenser 102.

Second beverage dispenser 104 includes a beverage containment portion 202 and a beverage dispensing portion 204.

Beverage containment portion 202 provides container for storage of beverages.

Beverage dispensing portion 204 provides for dispensing of beverage stored within beverage containment portion 202. Beverage dispensing portion 204 may be located on the front wall of beverage containment portion 202. Beverage dispensing portion 204 may be configured in color and shape to resemble a human female nipple.

Connection device 136 connects to beverage containment portion 202 via a strap 206.

Connection device 130 connects to beverage containment portion 202 via a strap 208.

Beverage dispensing occurs via beverage dispensing portion 204. Beverage dispensing portion 204 is located on the front of beverage containment portion 202. As a non-limiting example, beverage dispensing portion 204 is in the shape and appearance of a female nipple.

Beverage dispensing portion 204 contains an anti-vacuum skirt (not shown) located internal to beverage dispensing portion 204. In practical applications, without limitation, the anti-vacuum skirt may work by way of an anti-vacuum skirt in the base of the nipple where it forms a seal with the beverage dispensing unit allowing the air to go in but no liquid to exit. Anti-vacuum skirt operates to prevent a vacuum from forming inside of beverage dispensing portion 204. (Just reword this paragraph to fit the above mentioned.)

Beverage containment portion 202 is configured of materials safe for providing a consumable beverage. Non-limiting examples for materials include polyethylene terephthalate (PET), plasticized polyvinyl chloride (p-PVC), low-density polyethylene (LDPE) and polyamide.

Beverage containment portion 202 may be configured with a separate reservoir located internally. In practical applications, without limitation, the separate reservoir may help limit beverage from leaking when not consuming.

The base of beverage dispensing portion 204 is encircled by a circular device 205. Circular device 205 is configured to resemble the areola of a human female breast. As a non-limiting example, the diameter of circular device 205 is approximately 1 inch.

FIG. 3 illustrates an enlarged view of example second beverage dispenser as described with reference to FIGS. 1A-B and FIG. 2, in accordance with an embodiment of the present invention.

Beverage dispensing portion 204 includes a vertical opening 302 and a horizontal opening 304.

Vertical opening 302 provides an opening traversing vertically across beverage dispensing portion 204.

Horizontal opening 304 provides an opening traversing horizontally across beverage dispensing portion 204.

Vertical opening 302 and horizontal opening 304 provide openings where a beverage may be received by a user located external to second beverage dispenser 104.

Beverage dispensing portion 204 may be manufactured with a variety of duct sizes in order to adjust the rate of flow for the expelled liquid.

FIG. 4A illustrates a rear view of example beverage dispensing system as described with reference to FIGS. 1A-B, in accordance with an embodiment of the present invention.

A strap 402 connects to connection device 128. A strap 404 connects to connection device 120. A strap 406 connects to connection device 118. A first end of a strap 408 connects to a connection device 410. Connection device 410 connects to a strap 412. A second end of strap 408 connects to connection device 119 (FIG. 1).

A first covering pad 414 connects to and covers the rear of first beverage dispenser 102.

A second covering pad 416 connects to and covers the rear of second beverage dispenser 104.

As a non-limiting example, first covering pad 414 and second covering pad 416 may be configured as a swatch of fabric material. Non-limiting examples for fabric material include polyester, nylon, cotton or a blend of polyester, nylon and/or cotton. First covering pad 414 and second covering pad 416 may function to absorb any liquid resident on the surface of the beverage containment portions. Furthermore, first covering pad 414 and second covering pad 416 may function to absorb perspiration of a user (not shown). Furthermore, first covering pad 414 and second covering pad 416 may function to provide comfort to user.

A rear wall 422 and a rear wall 424 may be configured ergonomically in order to provide a comfortable fit for the user. Furthermore, rear wall 422 and rear wall 424 may be configured in a concave format. Furthermore, rear wall 422 and rear wall 424 may feature a soft exterior lining in order to provide comfortable contact with the chest of the wearer. In the present embodiment, 416 and 414 are the pads that may provide the comfortable contact.

FIG. 4B illustrates the rear view of example beverage dispensing system as described with reference to FIG. 4A with covering pads partially removed, in accordance with an embodiment of the present invention.

A liquid control device 418 is located in the rear, near the middle of first beverage dispenser 102.

A liquid control device 420 is located in the rear, near the middle of second beverage dispenser 104.

Liquid control device 418 and liquid control device 420 enable instilling and removal of liquid within containment portions. Furthermore, liquid control device 418 and liquid control device 420 may be configured to prevent leaking or exit of liquid from containment portions.

Alternatively, beverage dispensing system 100 may be filled via beverage dispensing portion 204. Furthermore, beverage dispensing portion 204 may be removed in order to fill beverage containment portion 202 with liquid. As a non-limiting example, beverage dispensing portion 204 may configured as a threaded device and may be removed by applying an angular force.

As a non-limiting example, a funnel device may be used as an aid for instilling liquids within beverage dispensing system 100. Furthermore, small end of funnel device may be inserted into liquid control device 420.

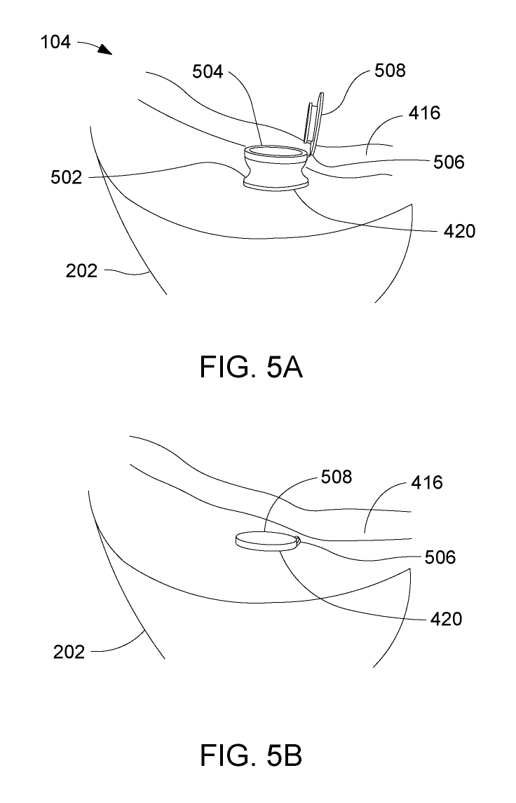

FIG. 5A illustrates a view of an example beverage dispensing device with an open liquid control device, in accordance with an embodiment of the present invention.

Liquid control device 420 includes a collapsible throat insert 502, a snap ring 504, a connection tab 506 and a cap device 508.

A first end of collapsible throat insert 502 connects to the rear of beverage containment portion 202. A second end of collapsible throat insert 502 connects to snap ring 504. Snap ring 504 connects to cap device 508 via connection tab 506. Alternate embodiments are contemplated that are not limited to a threaded device to be screwed on.

Liquid may be instilled within beverage dispensing portion 204 when cap device 508 is not inserted into collapsible throat insert 502. Furthermore, liquid may be instilled within beverage containment portion 202 when collapsible throat insert 502 is extended. Furthermore, after an appropriate amount of liquid has been instilled within beverage containment portion 202, beverage containment portion 202 may be sealed via cap device 508. Furthermore, collapsible throat insert 502 may be inserted within beverage containment portion 202.

Liquid control device 420 is located on the rear plane of first beverage dispenser 102 and second beverage dispenser 104. Furthermore, liquid control device 420 enables entry and exit of liquids. Furthermore, liquid control device 420 is sealable in order to prevent exit of liquids from liquid control device 420.

FIG. 5B illustrates a view of an example beverage dispensing device with a closed liquid control device, in accordance with an embodiment of the present invention.

Cap device 508 is inserted into snap ring 504 (FIG. 5A). Furthermore, collapsible throat insert 502 is inserted into beverage containment portion 202.

Configuration of cap device 508 inserted into snap ring 504 (FIG. 5A) and collapsible throat insert 502 inserted into beverage containment portion 202 prevents liquid from being expelled from beverage containment portion 202.

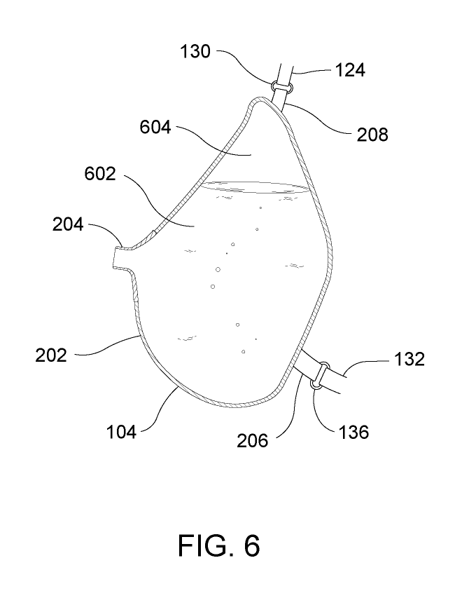

FIG. 6 illustrates a view of an example beverage dispensing device portraying an amount of liquid contained within the device, in accordance with an embodiment of the present invention.

A liquid 602 is contained within beverage containment portion 202.

An empty space 604 is contained above liquid 602 within beverage containment portion 202. As a non-limiting example, empty space 604 may contain air, carbon dioxide or other gaseous material.

Liquid 602 may be expelled from beverage containment portion 202 via beverage dispensing portion 204.

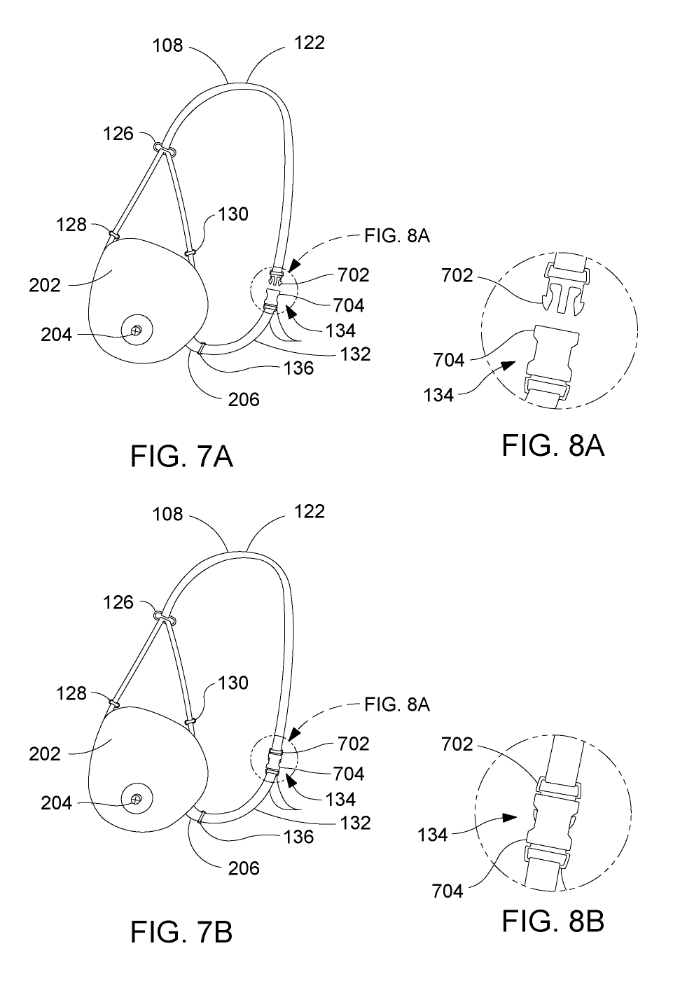

FIG. 7A illustrates a disconnected connection device for example beverage dispensing device, in accordance with an embodiment of the present invention.

Connection device 134 includes a male portion 702 and a female portion 704. As a non-limiting example, connection device 134 may be configured as a side release buckle.

Male portion 702 connects to strap 122 and female portion 704 connects to strap 132.

Male portion 702 is disconnected from female portion 704.

FIG. 7B illustrates a connected connection device for example beverage dispensing device, in accordance with an embodiment of the present invention.

FIG. 8A illustrates an enlarged view of a disconnected connection device for example beverage dispensing device as discussed with reference to FIG. 7A, in accordance with an embodiment of the present invention.

FIG. 8B illustrates an enlarged view of a connected connection device for example beverage dispensing device as discussed with reference to FIG. 7B, in accordance with an embodiment of the present invention.

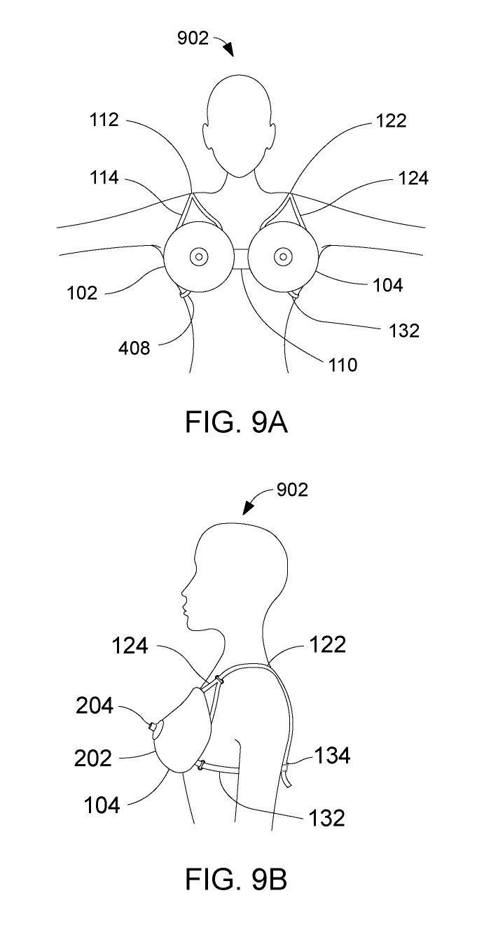

FIG. 9A illustrates an example application for example beverage dispensing device, in accordance with an embodiment of the present invention.

First beverage dispenser 102 rests on the right breast area of a person 902.

Second beverage dispenser 104 rests on the left breast area of person 902.

Strap 122 overlaps left shoulder of person 902.

Strap 112 overlaps right shoulder of person 902.

Strap 132 traverses under left arm of person 902.

Strap 408 traverses under right arm of person 902.

FIG. 9B illustrates a side view example application for example beverage dispensing device as discussed with reference to FIG. 9A, in accordance with an embodiment of the present invention.

In use, person 902 inserts arms through shoulder straps of beverage dispensing system 100. Furthermore, the straps may be adjusted for individual fitting and comfort. Furthermore, person 902 may drink beverage from beverage dispensing system 100 via liquid control devices. Furthermore, the process of person 902 applying a sucking action to liquid control devices activates an anti-vacuum skirt enabling the flow of liquid. Furthermore, other users (not shown) located external to beverage dispensing system 100 may also drink beverage from beverage dispensing system 100 in a similar manner as person 902.

Beverage dispensing system 100 may be worn by men or women, as the concave configuration of the beverage containment portions facilitates a female's breast or the pectoral muscles of a male.

As a non-limiting example application, beverage dispensing system 100 may be worm by men for breast feeding a child.

Those skilled in the art will readily recognize, in light of and in accordance with the teachings of the present invention, that any of the foregoing steps may be suitably replacedreordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of a beverage dispensing system according to the present invention will be apparent to those skilled in the art. The invention has been described above by way of illustration, and the specific embodiments disclosed are not intended to limit the invention to the particular forms disclosed. For example, the particular implementation of the liquid control device may vary depending upon the particular type liquid used. The liquid control device described in the foregoing was directed to less viscous liquid implementations; however, similar techniques for more viscous liquid implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An apparatus comprising:
two beverage dispensers each comprising a top, a bottom, a facing side, an outside side, a front wall, a back wall, a beverage storage portion disposed in a volume between said front wall and said back wall, a beverage dispensing portion disposed on said front wall, and a liquid control device disposed on said back wall;
a connecting mechanism being configured for joining said facing sides;
two strap mechanisms each being configured for supporting a separate one of said two beverage dispensers, each of said two strap mechanisms comprising a first strap portion being configured for joining to said top and for extending over a wearer's shoulder, and a second strap portion being configured for joining to said outside side and for extending about a side of the wearer, said first strap portion and said second strap portion being further configured for joining together to support said one of said two beverage dispensers on the wearer's shoulder with said one of said two beverage dispensers being disposed proximate a breast area of the wearer where the wearer can support the apparatus for dispensing the beverage.

2. The apparatus as recited in claim 1, in which said back wall comprises an ergonomic shape for fitting the wearer.

3. The apparatus as recited in claim 2, in which said ergonomic shape comprises a concave portion.

4. The apparatus as recited in claim 1, further comprising a covering pad being configured for joining to said back wall and for covering said back wall.

5. The apparatus as recited in claim 1, in which each of said two strap mechanisms further comprises a strap joining mechanism being configured for joining said first strap portion to said second strap portion and for adjusting a length of one of said first strap portion and said second strap portion.

6. The apparatus as recited in claim 5, in which each of said two strap mechanisms further comprises a first joining portion for joining said first strap portion to said top, said first joining portion comprising a first strap being configured for joining to said top, a first joining mechanism being configured for joining to said first strap, an extending strap being configured for joining to said first joining mechanism, and an extending strap mechanism being configured for joining said extending strap to said first strap portion.

7. The apparatus as recited in claim 5, in which each of said two strap mechanisms further comprises a second joining portion for joining said second strap portion to said outside side, said second strap portion comprising a second strap, being configured for joining to said outside side, and a second mechanism being configured for joining said second strap to said second strap portion.

8. The apparatus as recited in claim 6, in which each of said first joining portions further comprises an additional strap being configured for joining to said top, an additional joining mechanism being configured for joining to said additional strap, and an additional extending strap being configured for joining to said additional joining mechanism and to said extending strap mechanism.

9. The apparatus as recited in claim 1, in which said liquid control device comprises a collapsible throat insert, a snap ring being joined to said throat insert, and a cap device being configured for joining to said snap ring and for sealing said liquid control device.

10. The apparatus as recited in claim 1, in which said beverage dispensing portion comprises a nipple being configured for dispensing the beverage and a ring device surrounding said nipple.

11. The apparatus as recited in claim 10, in which said nipple comprises a vertical opening and a horizontal opening being configured to release the beverage.

12. The apparatus as recited in claim 10, in which said beverage dispensing portion is configured to be removable from said front wall.

13. The apparatus as recited in claim 5, in which said strap joining mechanism comprises a side release buckle.

14. The apparatus as recited in claim 10, in which said nipple is configured to resemble a nipple of a human female breast.

15. The apparatus as recited in claim 14, in which said ring device is configured to resemble an areola of a human female breast.

16. An apparatus comprising:
first means for dispensing a beverage;
first means for covering a back wall of said first dispensing means;
first means for supporting said first dispensing means on a first shoulder of a wearer with said first dispensing means being disposed proximate a first breast area of the wearer;
second means for dispensing a beverage;
second means for covering a back wall of said second dispensing means;
second means for supporting said second dispensing means on a second shoulder of the wearer with said second dispensing means being disposed proximate a second breast area of the wearer; and
means for joining said first dispensing means and said second dispensing means where the wearer can support the apparatus for dispensing the beverage.

17. An apparatus comprising:
a first beverage dispenser comprising a top, a bottom, a facing side, an outside side, a front wall, a back wall, a beverage storage portion disposed in a volume between said front wall and said back wall, a beverage dispensing portion removably disposed on said front wall, and a liquid control device disposed on said back wall, said back wall comprising an ergonomic concave portion for fitting a wearer, said beverage dispensing portion comprising a nipple being configured for dispensing the beverage and a ring device surrounding said nipple, said nipple comprising a vertical opening and a horizontal opening being configured to release the beverage, said liquid control device comprising a collapsible throat insert, a snap ring being joined to said throat insert, and a cap device being configured for joining to said snap ring and for sealing said liquid control device;
a first covering pad being configured for joining to said back wall of said first beverage dispenser and for covering said back wall;
a first strap mechanism being configured for supporting said first beverage dispenser, said first strap mechanism comprising a first strap portion being configured for joining to said top and for extending over a first shoulder of the wearer, and a second strap portion being configured for joining to said outside side and for extending about a side of the wearer, said first strap portion and said second strap portion being further configured for joining together to support said first beverage dispensers on the first shoulder of the wearer with said first beverage dispensers being disposed proximate a first breast area of the wearer;
a second beverage dispenser comprising a top, a bottom, a facing side, an outside side, a front wall, a back wall, a beverage storage portion disposed in a volume between said front wall and said back wall, a beverage dispensing portion removably disposed on said front wall, and a liquid control device disposed on said back wall, said back wall comprising an ergonomic concave portion for fitting the wearer, said beverage dispensing portion comprising a nipple being configured for dispensing the beverage and a ring device surrounding said nipple, said nipple comprising a vertical opening and a horizontal opening being configured to release the beverage, said liquid control device comprising a collapsible throat insert, a snap ring being joined to said throat insert, and a cap device being configured for joining to said snap ring and for sealing said liquid control device;
a second covering pad being configured for joining to said back wall of said second beverage dispenser and for covering said back wall;
a second strap mechanism being configured for supporting said first beverage dispenser, said first strap mechanism comprising a second strap portion being configured for joining to said top and for extending over a second shoulder of the wearer, and a second strap portion being configured for joining to said outside side and for extending about a side of the wearer, said first strap portion and said second strap portion being further configured for joining together to support said second beverage dispensers on the second shoulder of the wearer with said second beverage dispensers being disposed proximate a second breast area of the wearer;
a connecting mechanism being configured for joining said facing side of said first beverage dispenser and said facing side of said second beverage dispenser where the wearer can support the apparatus for dispensing the beverage.

18. The apparatus as recited in claim 17, in which said beverage dispensing portion is configured to be removable from said front wall.

19. The apparatus as recited in claim 17, in which said nipple is configured to resemble an areola nipple of a human female breast.

20. The apparatus as recited in claim 19, in which said ring device is configured to resemble an areola of a human female breast.
